(19) United States
(12) Patent Application Publication
(10) Pub. No.: US 2017/0149708 A1
(43) Pub. Date: May 25, 2017

(54) METHODS, SYSTEMS AND APPARATUS FOR AUTOMATED SERVICE REQUESTS AND/OR DATABASE BUILDING

(71) Applicant: CITY RANKED MEDIA, INC., Vancouver, WA (US)

(72) Inventor: Duane S. BAUMGARTNER, VANCOUVER, WA (US)

(21) Appl. No.: 15/248,283

(22) Filed: Aug. 26, 2016

Related U.S. Application Data
(60) Provisional application No. 62/210,474, filed on Aug. 27, 2015.

(51) Int. Cl. H04L 12/58; H04M 1/725; H04L 29/08; H04L 29/06

(52) U.S. Cl. CPC H04L 51/08; H04L 67/42; H04M 1/72563; H04L 67/306; H04M 1/72583

(57) ABSTRACT

Described herein are methods, systems and apparatus for displaying a user interface on a display of a mobile device responsive to activation of an application associated with a client account on a remote server on the mobile device, the user interface comprising one or more soft buttons configured to be actuated via a user input, capturing an image responsive to a user input activating a first soft button, generating a preformatted and pre-populated outgoing message responsive to either the capturing of the image or activation of a second soft button, attaching the image to the message and sending the message to a predetermined message address on the server associated with the client account responsive to a user input capturing of the image or attaching the image to the message. Also, described herein are methods, systems, and apparatus for, receiving a message from a mobile device comprising a user identifier and additional data comprising one or more of the following: a service request, an image, a video, an audio message, a review, a keyword or supplemental data, or combination thereof, identifying a user account associated with the message, associating the additional data retrieved from the message with the user account and forwarding the message to a management device.

### CROSS-REFERENCE TO RELATED APPLICATION

This application claims the benefit of U.S. Provisional Patent Application No. 62/210,474, filed Aug. 27, 2015, which is incorporated herein by reference for all purposes.

### BACKGROUND

Unless otherwise indicated herein, the approaches described in this section are not prior art to the claims in this application and are not admitted to be prior art by inclusion in this section.

Mobile devices such as mobile phones, tablet devices, laptop computers and/or slate devices are ubiquitous. Mobile devices are commonly equipped with cellular and network data communication capabilities as well as cameras, scanning devices, media players, recording devices and the like. Mobile devices are often capable of running one or more applications. Mobile devices may come with applications preinstalled and/or users may download any of a wide variety of applications available. Such applications vary in quality and usefulness. Applications for mobile devices tend to be directed to providing information, education, social networking, entertainment, gaming, navigation, e-commerce and like. Such applications are often offered free of charge in a reduce functionality state with the goal being sale of the fully functional application to users. The applications are usually not customizable except to the extent that users may enter personal information such as age, sex, weight, height etc. Furthermore, the applications are provided to explicitly sell a function or to offer a function in exchange for personal data collection or exposure to advertising. Mobile applications are underutilized as a tool to facilitate communication and relationship building between clients and service providers.

### SUMMARY

Mobile devices are not typically used to retain clients and to facilitate communication between clients and service providers. What is needed is a mobile application that can be used by service providers to enable their clients to quickly and easily reach out to the service provider for services, information and/or other relationship building communication, to automate one or more service requests and/or to build a database. Described herein are various illustrative methods for identifying, scheduling, tracking, monitoring and/or storing client services needs in association with a client retention application to automate one or more service requests and/or to build a database.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a mobile device, including: a processor configured to: execute an application associated with a client account on a remote server, display a user interface on a display of the mobile device responsive to activation of the application, the user interface including one or more soft buttons configured to be actuated via a user input. The mobile device also may generate a preformatted and pre-populated outgoing message responsive to either capturing of an image or activation of a first soft button of the one or more soft buttons. The mobile device also may send the message to a predetermined destination at the remote server responsive to a user input, capturing of an image or attaching the image to the message, or a combination thereof. Other embodiments of this aspect include corresponding computer systems, apparatus, and computer programs recorded on one or more computer storage devices, each configured to perform the actions of the methods.

One general aspect includes a method including: displaying a user interface on a display of a mobile device responsive to activation of an application associated with a client account on a remote server on the mobile device, the user interface including one or more soft buttons configured to be actuated via a user input, capturing, by the mobile device, an image responsive to a user input activating a first soft button, generating, by the mobile device, a preformatted and pre-populated outgoing message responsive to either the capturing of the image or activation of a second soft button, attaching, by the mobile device, the image to the message, and sending, by the mobile device, the message to a predetermined message address on the server associated with the client account responsive to a user input capturing of the image or attaching the image to the message. Other embodiments of this aspect include corresponding computer systems, apparatus, and computer programs recorded on one or more computer storage devices, each configured to perform the actions of the methods.

One general aspect includes a method including: receiving, at a server, a message from a mobile device including a user identifier and additional data including one or more of the following: a service request, an image, a video, an audio message, a review, a keyword or supplemental data, or combination thereof, identifying, by a processor, a user account associated with the message, associating, by the processor, the additional data retrieved from the message with the user account, and forwarding, by the processor, the message to a management device. Other embodiments of this aspect include corresponding computer systems, apparatus, and computer programs recorded on one or more computer storage devices, each configured to perform the actions of the methods.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several examples in accordance with the disclosure and are, therefore, not to be considered limiting of its scope, the disclosure will be described with additional specificity and detail through use of the accompanying drawings.

In the drawings:

FIG. 1 illustrates an example system to automate one or more service requests and/or to build a database, in accordance with various embodiments;

FIG. 2 illustrates an example mobile device to automate one or more service requests and/or to build a database, in accordance with various embodiments;

FIG. 3A illustrates an example user interface for a mobile device to automate one or more service requests and/or to build a database, in accordance with various embodiments;

FIG. 3B illustrates an example process for facilitating product and/or service review acquisition, in accordance with various embodiments;

FIG. 3C illustrates an example system for facilitating product and service review acquisition, in accordance with various embodiments;

FIG. 4 illustrates an example server to automate one or more service requests and/or to build a database, in accordance with various embodiments;

FIG. 5 illustrates an example of crowdsourcing images using an application to automate one or more service requests and/or to build a database, in accordance with various embodiments;

FIG. 6 illustrates an example management device to automate one or more service requests and/or to build a database, in accordance with various embodiments;

FIG. 7A illustrates an example process to automate one or more service requests and/or to build a database, in accordance with various embodiments;

FIG. 7B illustrates an example process to automate one or more service requests and/or to build a database, in accordance with various embodiments;

FIG. 7C illustrates an example process to automate one or more service requests and/or to build a database, in accordance with various embodiments;

FIG. 8A-FIG. 8B illustrate an example process flow for developing an application for automating one or more service requests and/or to build a database, arranged in accordance with at least some embodiments described herein; and

FIG. 9 is an illustration of a block diagram of an example computing device, all arranged in accordance with at least some embodiments described herein.

### DETAILED DESCRIPTION

The following description sets forth various examples along with specific details to provide a thorough understanding of claimed subject matter. It will be understood by those skilled in the art, however that claimed subject matter may be practiced without some or more of the specific details disclosed herein. Further, in some circumstances, well-known methods, procedures, systems, components and/or circuits have not been described in detail in order to avoid unnecessarily obscuring claimed subject matter.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, herein, to methods, apparatus, and systems related to identifying, scheduling, tracking, monitoring and/or storing information about client services needs.

Earning new business is often a difficult and lengthy process. Once the business has been earned, delivering a high-quality product or service is paramount. However, client retention is the mainstay of the service industry. Service providers rely on repeat business and must find ways to retain clients to provide ongoing services. One way that service providers can stay connected to and thus retain their clients is by providing an application that can be installed on a client's mobile device wherein the application is configured to automate one or more service requests and/or to build a database enhance which will facilitate the client/service provider relationship. The application can be used by clients to easily request service calls, make and schedule appointments, identify service needs (e.g., using images to identify household pests, maintenance needs, landscaping needs and etc.), update user accounts, pay fees, write and post reviews on review websites, share information about the service provider on social media, access data related to the services provided (e.g., an insect library, a plant catalog, the RMLS etc.) and so on. The application can also be used by the service provider to send clients various communications regarding their account, coupons and discounts, advice, billing, requests for referrals, alerts and the like.

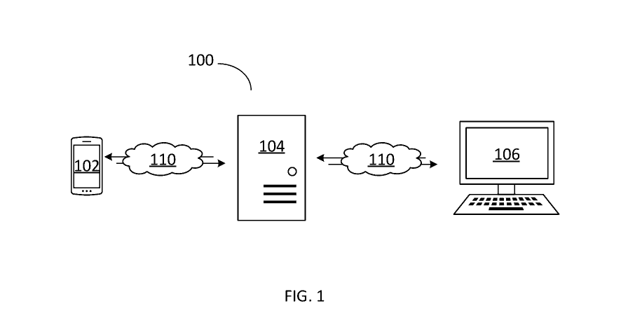

FIG. 1 illustrates an example system 100 to automate one or more service requests and/or to build a database to facilitate access to services provided by a service provider, in accordance with various embodiments. In the service industry, quickly responding to service requests is an excellent way to enhance the service provider/client relationship. A mobile application directed to facilitating service requests and enabling responses to those service requests will improve client retention rates. Service providers may include any of a variety of businesses that provide personal services, for example: pest control companies, landscape maintenance companies, attorneys, accountants, bookkeepers, fleet auto repair companies, daycare providers, carpet cleaners, computer repair technicians, doctors, physicians assistants, dentists, plumbers, limo drivers, tree service technicians, handymen, window cleaners, plumbing, janitorial service providers and etc.

System 100 is configured to improve client retention rates by facilitating client service requests and enabling the service provider to quickly and easily respond to the service requests. System 100 includes a mobile device 102 communicatively coupled to a server 104 over a network 110, and a management device 106 communicatively coupled the server 104. Mobile device 102 and management device 106 may also be communicatively coupled to one another. Network 110 may include any of a variety of networks. Such networks may include, the Internet, World Wide Web, a ubiquitous computing (ubicomp) environment, cloud computing system, Local Area Network (LAN), a Virtual Private Network (VPN), a Wireless Local Area Network (WLAN), a Wide Area Network (WAN), a Personal Area Network (PAN), and/or the like or any combination thereof. For the sake of simplicity system 100 is described herein to include a single mobile device 102, a single server 104, and a single management device 106. However, system 100 may include a plurality of mobile devices, servers, and/or management devices.

In an example, mobile device 102 is configured to download, store and run an mobile application designed to allow a user (e.g., a client) to automatically send a request for service to a service provider. The service request may include audio data, video data, image data, and/or text data. Server 104 is configured to manage and update the mobile application, manage client accounts, authenticate mobile application users, receive the service requests, store the audio data, video data, image data, and/or text data received in the service requests, provide access to one or more databases, analyze data received in service requests, push notifications to the mobile device 102 via the application, and/or route the service requests to management device 106, or the like or any combinations thereof. Management device 106 is configured to store and run a version of the mobile application that provides additional administrative functionality. A service provider may immediately receive and respond to a service request sent from mobile device 102 either via the management version of the application or via another communication means such as email or phone call.

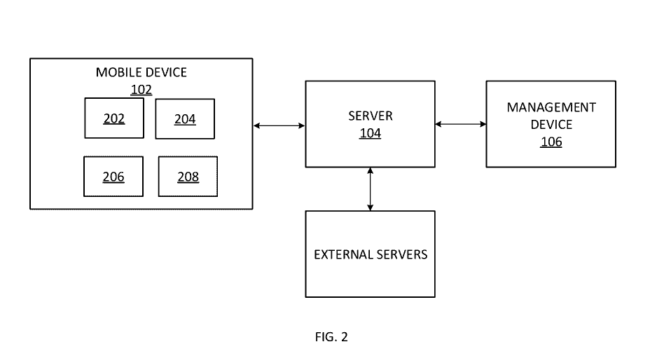

FIG. 2 illustrates an example mobile device having stored thereon an application to automate one or more service requests and/or to build a database to facilitate access to services provided by a service provider, in accordance with various embodiments. In an example, an application 202 is stored on mobile device 102. For the sake of simplicity and clarity application 202 is described herein as a mobile application operating on a mobile device, however, application 202 may comprise a wide variety of computer program products, which may be included in a wide variety of computing devices such as desktop computing devices, server type computing devices, handheld computing devices, tablets, smart phones, wearable smart devices, or the like or any combination thereof. Application 202 facilitates and enhances the service provider/client relationship by making it easier for the client to contact the service provider, access services from the service provider, request and schedule services, provide important personal and/or service related information to the service provider, receive notifications (e.g., coupons, discounts, alerts, etc) from the service provider, and/or send data to the service provider (e.g., location data, audio data, image data, and/or video data). Mobile device 102 is a communications device capable of communicating via any of a variety of communications networks. Further, mobile device 102 is equipped with a camera 204, an audio recording device 206, and/or a video recording device 208. Camera 204 and/or video recording device 208 may comprise a wide variety of imaging devices. Such imaging devices may include, an analog type video recorder, an imaging device utilizing charge-coupled devices (CCD), an imaging device utilizing complementary metal-oxide semiconductor (CMOS), a thermal imaging device, a near-infrared imaging device, or the like, and any combination thereof. Mobile device 102 also includes a processor 208 configured to execute application 202 associated with a client account on remote server 104.

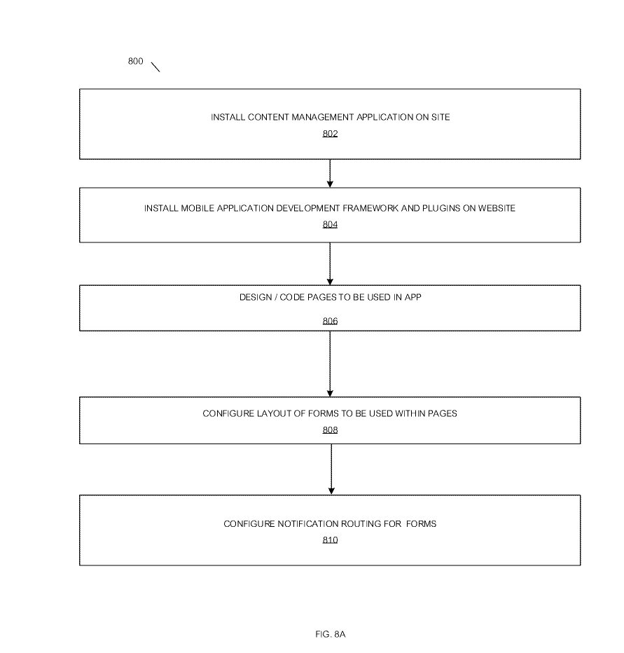

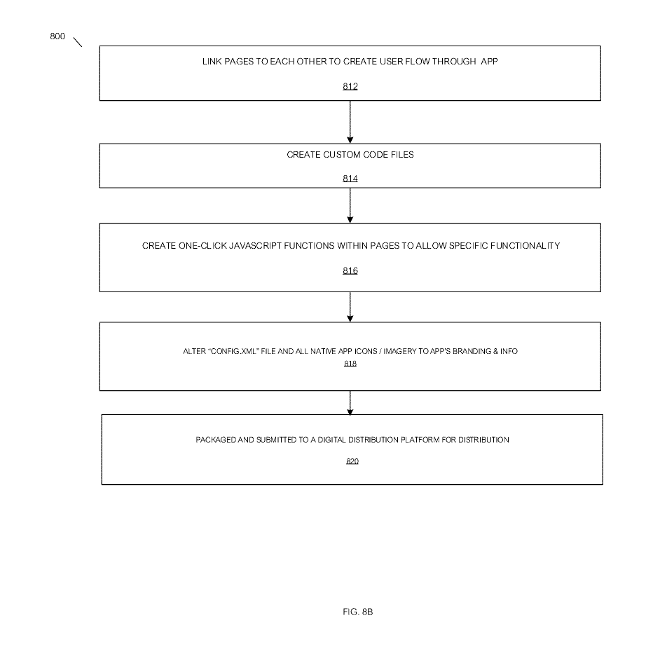

In an example, application 202 may be developed from the ground up using any of a variety of suitable programming languages or may be developed using any of a variety of content management systems and/or plugins in addition to custom coding, see for example, FIG. 8A-FIG. 8B.

In an example, application 202 may be downloaded to a user's mobile device 102 from a service provider's website and/or downloaded from any of a variety of digital distribution platforms such as Google play or the Apple App Store. The user may be a service provider's client.

Once installed, application 202 may be accessed by a user (e.g., a client). In some examples, application 202 may require the user to present authentication data to gain access to full functionality of application 202. Upon authentication application 202 may be associated with a user's account on server 104 base on the authentication data. The user's account may include account data such as service contract information, personal data, service history, payment history, billing information, service schedule, and the like or any combinations thereof.

Once accessed, application 202 displays a user interface on a display of mobile device 102. The user interface may comprise graphics including logos, service marks, trademarks and other artwork corresponding to the service provider's website. In an example, application 202 may access, use and/or update application 202 graphics with the graphics used on the service provider's website by accessing the server hosting the service provider's website where the graphics are stored. For example, the service provider's website may be hosted on server 104.

The display on mobile device 102 may be a touchscreen. The user interface may include one or more soft buttons to trigger application functions. The soft buttons are configured to be actuated via a user input such as touching or swiping with a fingertip and/or stylus. Other inputs such as voice or percussion may trigger various functions in application 202 as well. The soft buttons may identify functions available in application 202.

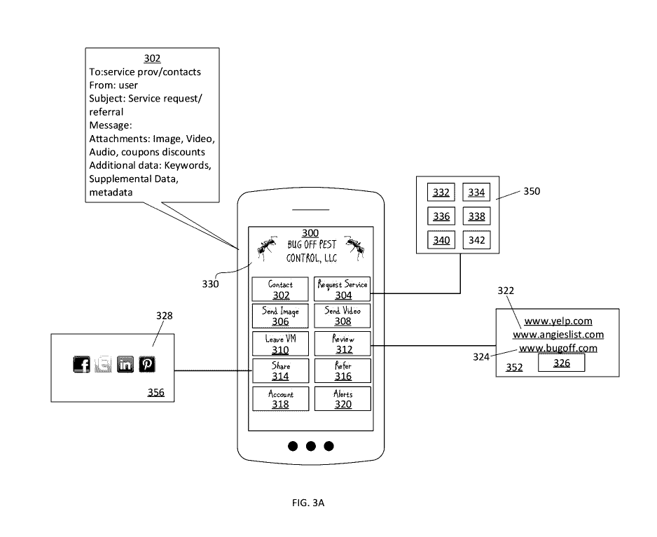

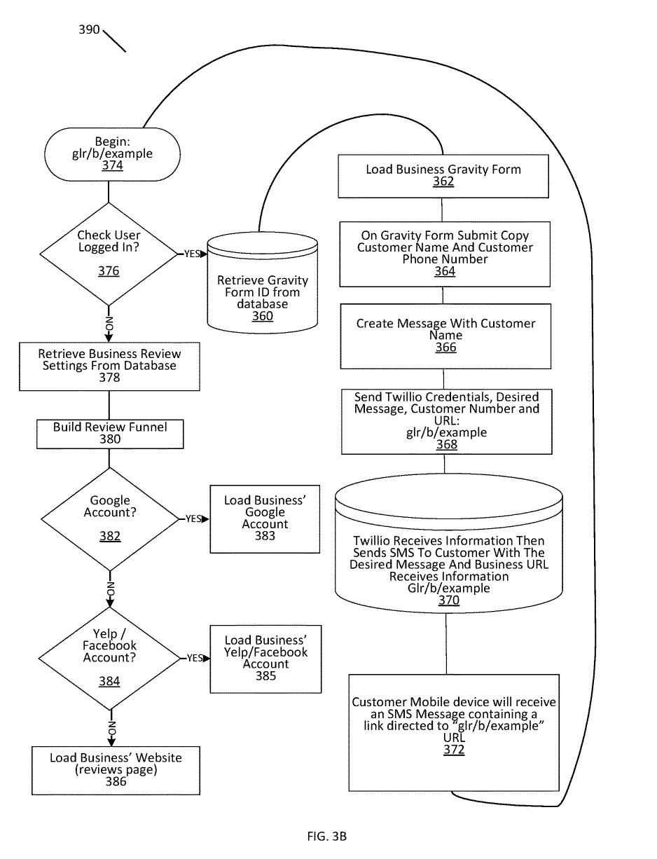

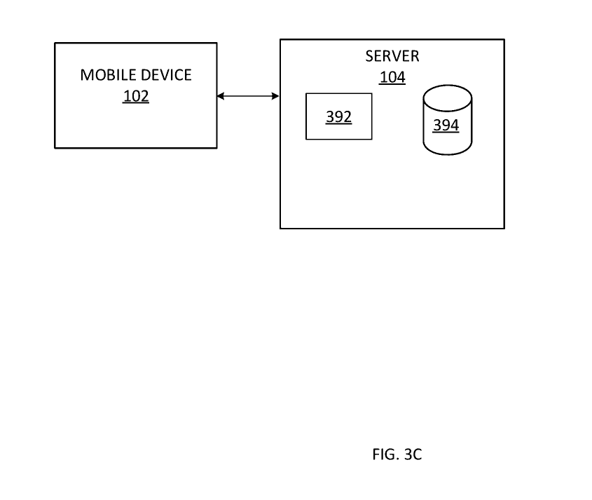

FIG. 3A illustrates an example user interface for mobile application 202 to automate one or more service requests and/or to build a database to facilitate access to services provided by a service provider, in accordance with various embodiments. In an example, user interface 300 may include a contact soft button 302, a request service soft button 304, a send image soft button 306, a send video soft button 308, a leave voicemail soft button 310, a review soft button 312, a share soft button 314, a refer us soft button 316, a pay bill soft button 318, and an alerts soft button 320.

In an example, selection of one or more soft buttons on user interface 300 may trigger application 202 to generate a message 302. The message 302 may be pre-populated and/or pre-formatted to facilitate communication between the user (client) and service provider. As discussed in more detail with reference to the specific soft buttons below application 202 may automatically attach or include in message 302 one or more of the following image data, video data, audio data, keyword, unique user identifier, name, address, account number, phone number, service plan, service history, service preferences, billing plan or payment information or the like, or any combinations thereof. Moreover, application 202 may access supplemental data stored on mobile device 102 and may insert the supplemental data into a predefined field in message 302. The supplemental data can include one or more of the following: weather data, location data, social media data, contact data, user data or browsing history, mobile device 102 ID, time, date, a service requested, a speed, a direction of travel, or the like or any combination thereof. Mobile application 202 as configured to send message 302 to a server 104. Server 104 is configured to copy one or more of the image data, audio data, video data, keywords, user data, and/or supplemental data present in message 302 and store the copied image data, audio data, video data, keywords, user data, and/or supplemental data in association with the user account. The image data, audio data, video data, keywords, user data, and/or supplemental data may also be used by server 104 two build one or more databases related to the service provider's services such as a pest library, medical dictionary, horticultural library or the like or any combinations thereof.

In the example, message 302 may be generated in any available format. Message 302 may comprise an email message, multimedia messaging service (MMS) message, a Short Message Service (SMS), or a software based messaging application message, or a combination thereof.

Returning to FIG. 3, in an example activating contact button 302 initiates a contact function in application 202. The contact option may automatically pull up contact information for the service provider. For example, service provider “Bug Off Pest Control LLC's” phone number, email, address, and/or other contact information may be provided in a window on display 330. Links accessing the corresponding communication functionality of mobile device 102 pre-populated with the specific contact information may be provided in the contact window. The address may be a link to a navigation program providing a map to the address. Contact information provided via mobile application 202 may be updated from the service provider's website.

Responsive to a user input selecting request service button 304, mobile application 202 will generate a preformatted and/or pre-populated outgoing message addressed to the service provider. Upon activation of request service button 304 a user may be presented a window with a variety of user options. In an example, a request service window may include soft buttons to prompt the user to upload an image and/or video, select keywords related to their service need, request a service perhaps even from a drop-down listing of services available, schedule the service or identify available times, select a location, identify and urgency level which will indicate how quickly the service provider is expected to respond, and/or leave a voice message or the like or any combinations thereof.

For example, mobile application 202 may be customized for a pest control business. The user may be a client of the pest control company, “Bug Off Pest Control.” If the user sees a pests in their home, the user may open mobile application 202 and select request service button 304. A request service window 350 may open presenting one or more soft button options to enable the user to quickly and easily request a pest control service. Selecting the request service soft button 332 also automatically generates a message requesting a service that is preformatted and/or pre-populated to be sent to the service provider.

In an example, the user may select upload image/video soft button 332 which will automatically access mobile device 102's camera/video functions. The user may take a picture or video, that picture/video will automatically attach to message 302. Capturing the picture/video may also trigger sending message 302 and/or the user may manually send message 302.

Another request service soft button option provided in window 350 may be keyword soft button 334 from which a user may be presented a drop-down list of keywords related to the service the user is requesting and/or related to the image/video being sent, for example. The keywords may be used by the service provider to identify the pest (e.g., mammal, insect, reptile, color, number of legs, size etc.). The keyword(s) will be automatically attached to message 302.

Urgency level soft button 336 may be provided to enable the user to select an urgency level. Urgency level will be automatically included in message 302. Schedule service soft button 338 may permit the user to select a particular service date and time and/or define a window of availability. In an example, mobile application 202 may be frequently updated based on the service provider's website and/or information stored in server 104. Thus, schedule service soft button 338 may provide access to the service provider's current scheduling calendar. Information provided by the user such as the request for a particular schedule date and time and/or a defined availability may be inserted into message 302 by application 202. Voicemail soft button 340 a permit the user to record an audio message that will be automatically attached to the outgoing message generated by application 202. Select location soft button 342 will permit user to select a location if the service is not an in-home service. The location selected will be identified by the mobile device in the outgoing message generated by application 202. The foregoing are examples of options that may be presented to the user accessing application 202. It is contemplated that application 202 may provide one or more of these options and/or additional options in request service window 350.

In an example, application 202 may include soft button send image 306 configured to access a camera function of mobile device 102 to permit the user to capture an image. Accessing soft button send image 306 will automatically generate a message and attach the image to message 302. Application 202 will send message 302 to server 104 which will forward message 302 to management device 106 responsive to receiving message 302.

Likewise, application 202 may include soft button send video 308 configured to access a video camera function of mobile device 102 to permit the user to capture a video. Accessing soft button send video 308 will automatically generate a message and attach the video to message 302. Application 202 will send message 302 to server 104 which will forward message 302 to management device 106.

Leave voicemail soft button 310 enables the user to access audio recording functions of mobile device 102 to record a voicemail message. Responsive to recording an audio message application 202 will automatically forward the recorded audio as a voicemail message to server 104 to be routed to management device 106.

Review soft button 312 may be selected by the user to provide a review of the service provider' services. Selection of review button 312 may open a review window 352. Review window 352 may provide links 322 to commonly used review websites, a link 324 to a review page on the service provider's website, and/or a text box 326. From review window 352 the user may access the commonly used review websites or review web page on the service provider's website via links provided to review the service provider's services. Alternatively, the user may provide a review in the text box. Selection of text box 326 may trigger application 202 to generate a message that is preformatted and/or pre-populated and addressed to a predetermined destination. Text entered into text box 326 may be inserted into message 302 and may be forwarded to server 104 by application 202. Server 104 may automatically publish the review provided in the text box to the service provider's website. This may be convenient where the review is a numerical rating. Server 104 may be programmed to only publish reviews greater than a certain value. In another example, server 104 may provide a written review to the service provider for manual review before publishing. Alternatively, the server 104 may comprise an algorithm for automatically checking the review to identify whether or not the review is good or bad and then only publish to the service provider's website the reviews determined by the algorithm to be good. The review by server 104 may be based on a variety of automated evaluation or rating techniques such as semantic analysis.

In an example, share soft button 314 may open window 356 to display links and/or icons to one or more social media outlets. The user may select one or more of the social media outlet links and/or icons to share information about the service provider. Application 202 may be configured to populate a share window corresponding to a particular social media outlet with any of a variety of data points about the service provider, for example contact information, news article, reviews, website information, coupons or other offers, or the like or any combinations thereof.

In an example, refer soft button 316 may enable user to easily refer the service provider to friends and family. Responsive to selection of refer soft button 316 application 202 may generate a message, access the user's contacts, address message 302 to one or more of the user's contacts, pre-populate message 302 with information about the service provider, include reviews provided by the user in message 302, include offers and/or coupons in message 302, open a text box to permit the user to include a personal note to be attached in message 302 or the like or any combinations thereof.

In an example, account soft button 318 may enable the user to access their account with the service provider. Authentication may be required. Application 202 may open a portal to the user's account stored on server 104 responsive to selection of account soft button 318. Via the portal the user may make a payment to the service provider, revise personal information, schedule an appointment, review account history, upgraded account or the like or any combinations thereof.

In an example, alerts soft button 321 selected by the user may access one or more alerts related to the service provider's services.

In the example, automated review requests may also be provided as a standalone review application or plug-in rather than review request soft button 312. The standalone review application or plug-in may be web-based and compatible with a variety of mobile devices such as smart phones, tablets, slate devices, Smart watches as well as a variety of other internet connected device. The automated review request application may be easy to use. In general, the review application may be associated with the service provider's website and thereby access a service provider's website content, authentication information, contact information, payment information, supplemental information or the like or any combination thereof. In another example, a service provider may access the review application separate from a service provider's website and provide authentication information, payment information, contact information, etc. upon accessing the application. In an example, the review application provides a form for a service provider to enter customer information such as customer name and a mobile device number. Submission of this information triggers the review application to send an SMS text message to the identified customer's mobile device. The SMS message provides to the identified customer mobile device a text message with a custom message from the service provider and a link to a website hosting the review application. The review application server (e.g., server 104) sends queries to the customer regarding the customer's subscriber status with various review platforms (e.g., Yelp, Google, Angie's List). When/if a review platform is identified to which the customer is a subscriber then the application server determines whether the subscriber (i.e., customer) is authenticated with the review platform. If not the application triggers the authentication process with the review platform and then after authentication of the subscriber (customer) the application redirects the customer's mobile provide browser to the specific service provider's business page on the identified review platform's website.

Furthermore, a service provider or other user may open the review application and in the fields provided may enter certain information such as, a customer's name, cell phone number and optionally the service provider may enter the employee's name who is requesting the review. Entering the employees name may allow the service provider (client) to collect data on which employees are requesting reviews. The service provider may then submit the information. Based on the submitted information the review application is triggered to generate and send an SMS text message to the identified customer's cell phone number which was entered in the provided fields. A message can also be attached thanking the customer for using the company and asking them to leave a review by visiting an embedded link via their mobile device.

The link provided in the SMS text message directs the mobile device processor to a web browser which opens up to a dialog box asking a number of questions regarding review platforms. For example, the application may inquire whether the customer uses Gmail or Google apps and may provide a yes or no soft button or other graphical user interface to receive user input from the customer. If the customer answers ‘yes’ the application causes the browser to determine whether the customer is already logged into Google. If the customer is logged in, the application will direct the mobile device browser to the service providers “Google My Business” page. From there, the customer can simply write and submit a review.

On the other hand, if the customer is not logged in to Google apps or Gmail, the review application will trigger Google to ask the customer to log in to leave the review, after authentication the application directs the browser to the review screen. If the customer selects ‘No’ they don't use Gmail or Google Apps, then responsive to the negative the review application's next screen offers an alternative review platform option. For example, the application may generate a graphical user interface or dialog box that inquires whether the customer/user is a Yelp subscriber and the process continues with variety of review platforms including for example Facebook, Amazon, Angie's List or a custom review website such as City Ranked Reviews at https://cityranked.com/seo-sem-website-company-reviews/. A “Success” screen confirmation that the text message has been sent is provided to the service provider and/or the service provider will receive an email notifying them that a review request has been initiated, along with the employee's name that requested the review.

FIG. 3B illustrates a process 390 for automating review requests from a service provider. The application is configured to provide review platform alternatives to a customer in order to facilitate acquisition of a review by the service provider from one of their customers. In an example, utilizing WordPress the review plugin is set-up by creating a custom post type for Wordpress. This custom post type may be called ‘business’. The review plug-in is referred to herein as Go Local Review (GLR). The GLR script next creates an admin section in the back of the website for each ‘business’. This form houses each business' review information including: Business' Name, Business' Gravity Form ID Number, An SMS message to be delivered to the business' end user, Business Review Locations, Google, Facebook, Yelp, Business' own website reviews and the like or any combinations thereof. When the GLR custom post type, business, is saved the script stores each business' information as the post's metadata. When saved a URL will be generated for each business under the custom post type, ‘business’. (ie /business/example-business/). Usage of the GLR script entails: When a user navigates to the generated URL: (e.g., https://golocalreviews/business/example-business/), Go Local Reviews runs a template file, ‘single-business.php’. The GLR single-business template script checks if the user is logged in. If the user IS logged in then: The script checks the database for the intended Gravity Form by ID, the script then loads the appropriate Gravity Form, (Skip to ‘Upon Submission of Gravity Forms’). If the user IS NOT logged in then, the script checks the server for the business' review platforms and links, the Review locations then loads the appropriate review platforms into the Review Funnel, the Review Funnel is made up of yes or no questions, 1) ‘Do You Have A Gmail or Google Account?’ where Yes->links to the Google Account stored in the business' GLR business and No->Retrieves next review site from Server. Scrip loads the next review site question ‘Do you have a Yelp/Facebook Account?’ where Yes->Yelp/Facebook (opens site) and No->Business Website (opens site) OR—the user can scroll down to ‘login’ to login.

Upon Submission of Gravity Forms (After “IF the user IS logged in’): The GLR script copies the Customer Name and Customer Phone number from the form. The script retrieves the desired message from the back end of the business custom post type and adds the customer's name to the message. The GLR script sends Twilio account credentials, the constructed message along with the end user's phone number to Twilio.

End User—Upon SMS Receipt: The end user will receive the constructed message and a link to the business generated URL: (e.g., https://golocalreviews/business/example-business/). This will send the end user down the Review Funnel. (Back to Usage St ‘If the user IS NOT logged in’).

FIG. 3B is a flow diagram illustrating an example process 390 for automating and simplifying customer review acquisition using a standalone application and/or plug-in. The following example describes application process 390 using WordPress to provide an application and/or plug-in to facilitate acquisition of customer review data. However, the example is illustrative and not intended to be limiting any respect. Applications and or plug-ins with the functionality described herein may be built on a variety of platforms in a variety of code languages and claimed subject matter is not limited in this regard. Process 390 starts at process block 360 where a Gravity Form ID is retrieved from a database. A Review Protocol default setting assumes that a Gravity Form has been set up with at least two form fields. Form field 1 will house the end user's name. Form Field 2 will house the end user's phone number. Process 390 continues to process block 362 where the business Gravity Form is loaded. Process 390 moves to process block 364 where the user (service provider) may submit customer information such as customer name and customer phone number in a Gravity Form. Process 390 proceeds to process block 366 where the application and are plug-in associates a message with the customer name. The message may be stored and are manually provided by the service provider when accessing the application and/or plug-in. At process block 368, an SMS messaging service as accessed by the application and/or plug-in. In this example, Twillio credentials, the desired message, the customer number, and URL pointing to a web-based review application hosted on server are sent to the SMS messaging service. The SMS messaging service is configured to send SMS messages from applications and/or plug-ins. Process 390 moves to process block 370. The SMS messaging service (Twillio) receives the information and responds by sending an SMS message to the identified customer with the desired message and the business URL. Process 390 moves to process block 372 where the SMS messaging service sends a mobile device associated with the customer number provided in Gravity Form (at process block 364) the SMS message including the desired message and URL (e.g, glr/b/example). Process 390 moves to processing block 374 where a user/customer may access the URL (sent in the message) from the mobile device associated with the customer number. Accessing the URL launches the review application and/or plug-in on server (e.g., server 104). Process 390 moves to process block 376 where the application checks to see if the user accessing the application is logged in if the user is logged in the process moves back to process block 360. If the user is not logged in, process 390 moves to process block 378 where the application retrieves the business review settings from a database. Process 390 moves to process block 380 where a review funnel is built. The review application at this point redirects the mobile device browser to a review website (e.g., Google Business). Process 390 moves to process block 382 where the review application determines whether the user/customer is a subscriber to the review website if yes the process proceeds to process block 383 where the specific business' Google account associated with the service provider's business is loaded so that the user can leave a review regarding the service provider's products and/or services. If the user is not a subscriber to the review website the process moves to process block 384 where another review website is accessed and the review application can determine whether the mobile device user is a subscriber. The review application will cycle through a predetermined list of review websites. When the review application determines that the user associated with the mobile device is a subscriber to one of the review websites it will redirect the mobile device browser to the service provider's specific business page at process block 385 so that the mobile device user can leave a review. If the user associated with the mobile device is not a subscriber to any of the review website options then the process moves to process block 386 where the application redirects the mobile device browser to load the service provider's specific website review page on the service provider's own website where the user/customer associated with the mobile device can leave a review. Mobile devices discussed herein include any device capable of receiving an SMS message.

FIG. 3C illustrates an example system 396 for facilitating product and service review acquisition. In an example, server 104 can store and host application 392 and database 394. Server 104 is configured to communicate via an SMS messaging system with mobile device 102. Application 392 is configured to operate and perform functions as described above with respect to FIG. 3C. Furthermore, database 394 is configured to operate and perform storage, access and retrieval functions as described with respect FIG. 3B (when discussing the database configured to store the service provider's user and business information).

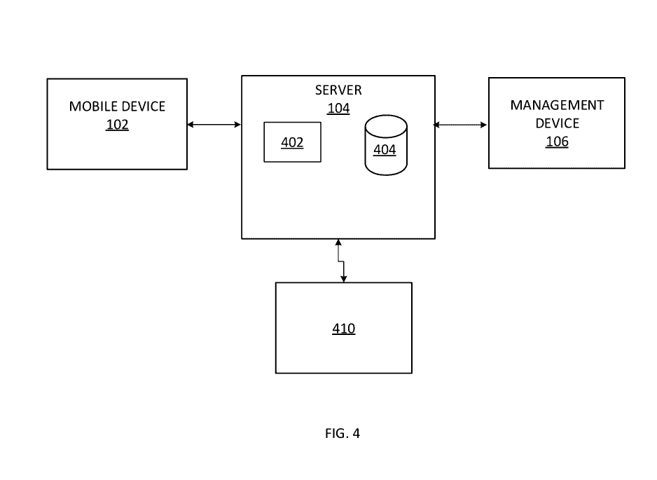

FIG. 4 illustrates an example server to automate one or more service requests and/or to build a database to facilitate access to services provided by a service provider, in accordance with various embodiments.

In an example, server 104 is configured to receive a message 302 from mobile device 102. Message 302 may include image data, audio data, video data, keywords, user data, and/or supplemental data or the like, or any combinations thereof. Server 104 may be configured to identify a user account based on data in message 302. Server 104 may copy image data, audio data, video data, keywords, user data, and/or supplemental data or the like or any combinations thereof. Server 104 may save image data, audio data, video data, keywords, user data, and/or supplemental data or the like or any combinations thereof. Furthermore, server 104 may associate image data, audio data, video data, keywords, user data, and/or supplemental data or the like or any combinations thereof with the identified user account. Responsive to receiving message 302, server 104 may forward message 302 to a management device 106. Management device 106 may be operated by the service provider.

In an example, management device 106 may be running a version of application 202 with additional functionality and for example including administrative tools. Thus, a service provider may exercise some control over how application 202 is managed by server 104. From the management version of application 202 a user via management device 106 may select data to be forwarded with message 302 from server 104. This information may be stored on server 104 in memory 402. For example, the service provider may want images or video to be forwarded so that the service provider may respond to the message with service recommendations based on the images and/or video but may not need supplemental data. Thus, server 104 when forwarding message 302 to management device 106 may forward only a subset of image data, audio data, video data, keywords, user data, and/or supplemental data or the like or any combinations thereof received in message 302.

In an example, server 104 may develop and/or store a database 404. Database 404 may comprise a database management system such as MySQL, PostgreSQL, Microsoft SQL Server, Oracle, Sybase and IBM DB2 configured to capture and analyze data. Server 104 may include several databases 404. Database 404 may store data in a variety of data structures known to those of skill in the art including, trees, hierarchical data structures, maps, lists, sets, arrays, hashes, etc. or any combinations thereof. Server 104 may store data on storage device 402 which may comprise any of a wide variety of storage types such as, but not limited to, mechanical, optical, electrical, etc., and any combinations thereof. Additionally, storage device 402 may include machine readable instructions.

When server 104 receives message 302, server 104 may analyze message 302 and identify data to be stored in database 404 based on the analysis. Message 302 may be organized with specific fields to identify the type of data entered into the various fields. For example, image data may be entered into an image field, keyword data may be entered into a keyword field, and/or supplemental data may be entered into a supplemental data field. The relationships between fields may be known. Thus, the database management system of database 404 may relate data based on the known relationships between fields. Database 404 may extract the data from the specified fields of message 302 and organize the data in database 404 based on the field from which the data was extracted. For example, server 104 may extract an image and/or video from message 302 as well as one or more keywords. The relationship between keywords and image data be known in that keywords may identify the image and/or video. Thus, a library of images and identifying keywords may be built based at least in part on data received in one or more messages 302. Supplemental data and metadata received in message 302 may also be stored in database 404 and associated with the image and/or video. Data received in message 302 may be used to build or enhance a useful resource library such as a pest library and/or a plant library. Database 404 may be accessed by application 202 to permit the user to search database 404. Management device 106 may have greater access to database 404 than mobile device 102. For example, management device 106 may be authorized to build, edit and/or manage database 404 whereas mobile device 102 may merely search database 404.

In another example, information related to message 302 such as services requested, supplemental data, keywords, metadata, referral information and the like or any combinations thereof may also be stored in database 404 and associated with a client account. In this way an account history for particular user may be stored and accessed by management device 106. Such data may be also be useful to a service provider to develop a client profile and over time to be able to anticipate/predict future client services needs. For example, a client may request a pest control service call to exterminate sugar ants on or about April 15 every year or whenever the weather warms to above 70°. Based on this pattern, a pest control service provider may suggest a service call for April 1 or any time the weather warms to above 70° in order to prevent the sugar ant infestation. In another example, clients with high referral rates may be tracked so that a service provider may provide incentives to that particular client to encourage continued referrals.

Server 104 may be configured to perform image analysis. Image analysis functionality may be embodied in any of a variety of algorithms, applications and/or programs in hardware, firmware and/or software. Server 104 may identify attributes in image and/or video data received in message 302 and may store the attributes in association with the corresponding image data and/or video data in database 404. The attributes may also be used to identify an object in the image data and/or video data. For example, upon receipt of message 302 server 104 may perform image analysis on image data and/or video data received in message 302. Server 104 may search database 404 to identify like attributes and may identify an image or video stored in database 404 based on a match of one or more attributes identified in images/video received in message 302. In another example server 104 may access external database for 10 to identify an object captured in image data and/or video data based on attributes identified in the image data and/or video data.

When server 104 forwards message 302 to management device 106 server 104 may include results of the image analysis so that a service provider may more easily identify objects captured in the image data and/or video data. Management device 106 may also access server 104 and access image analysis functions of server 104 to identify an object captured in image data and/or video data whether or not provided in message 302.

In another example, server 104 may associate service treatment plans with image data. Thus, if an object in an image that is received in message 302 as identified in database 404 a treatment plan may also be identified along with the object. All of this information may be forwarded to management device 106 with the message 302 to provide the service provider with an identified treatment plan related to the service request contained in message 302.

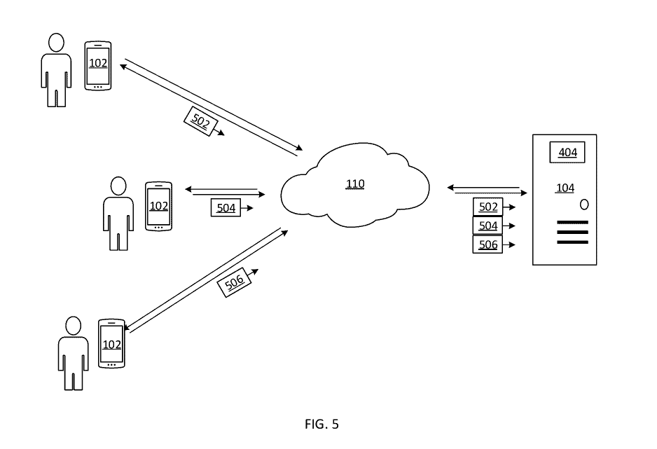

FIG. 5 illustrates an example system for crowdsourcing data using a mobile device application to automate one or more service requests and/or to build a database to facilitate access to services provided by a service provider. In an example, a plurality of mobile devices 102 may be communicatively coupled to server 104 over a network 110. The plurality of mobile devices 102 may be configured to run mobile application 202. Mobile devices 102 may each be associated with a different client of a particular service provider. Each of these clients may access application 202 at various times and may send various images 502, 504, and 506 two server 104. Images 502, 504, and 506 may be analyzed and stored in database 404 as described above with respect to FIG. 4. In this way, images may be crowdsourced. For example, pest and insect photography online is hard to source. The sheer volume of different insects in the United States, plus the relative low demand for these photos outside of the pest control industry makes it hard to come up with photos for website use for pest control companies. Using mobile application 202 pest control clients can take and upload pictures to server 104. These pictures can be catalogued in a pest identification library that is ever growing and accessible through mobile application 202. Cataloging may be accomplished using image analysis and/or verification by a certified entomologist. Cataloging by a certified entomologist may require service provider to update database 404 manually via management device 106 running application 202.

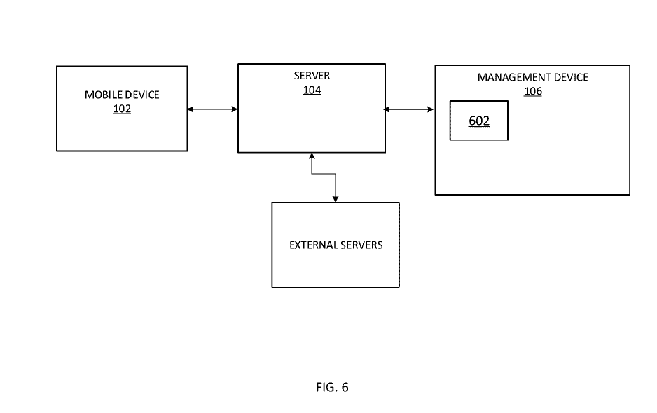

FIG. 6 illustrates an example management device to automate one or more service requests and/or to build a database to facilitate access to services provided by a service provider, in accordance with various embodiments. In an example, management device 106 may comprise a wide variety of computing devices such as desktop computing devices, server type computing devices, handheld computing devices, tablets, smart phones, wearable smart devices, or the like or any combination thereof. Management device 106 may be configured to run a management application 602 which may be a broader version of application 202 that provides all of the functionality available in application 202 as well as providing additional access to server 104. In an example, from management device 106 a user (e.g., a service provider) may directly upload images to database 404 in order to build a content library such as a pest library or plant library. Management device 106 may be able to utilize it database management system running on server 104 such as MYSQL in order to assign access to client mobile devices 102 at a point of sale or any other time. Application 602 may receive updates from server 104 on a regular and/or periodic basis notifying management device 106 when application 202 contacts server 104.

Server 104 stores address data of the service provider's clients. These clients may have mobile devices 102 running application 202 as well. Thus, location data may be collected at server 104 based on messages 302 from the mobile devices used by clients. This location data enables application 602 to target a particular geographic area with incentive offers, alerts and other notifications based on stored address data and/or location data collected from client mobile devices. In an example, some service providers work on a “vehicle route” basis wherein a particular vehicle services a predefined geographic area. Commonly most route based businesses, the smaller and more concentrated your vehicle route is, the more profitable. With application 602, the geographical area proximate a particular vehicle route may be targeted with an incentive offer in order to increase the concentration of services along the vehicle route. Vehicle route targeting may be based on address data stored on server 104. In another example, a current location of the service provider's clients may be available based on location data transmitted by application 202 to server 104 on a routine and/or periodic basis. With this dynamic location data the service provider may send incentives or other notifications to clients whose location is identified as being proximate a service provider location.

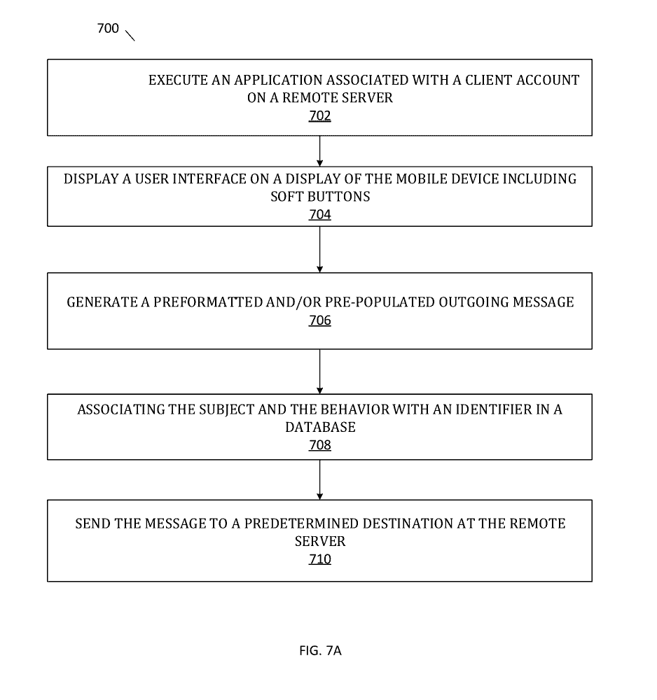

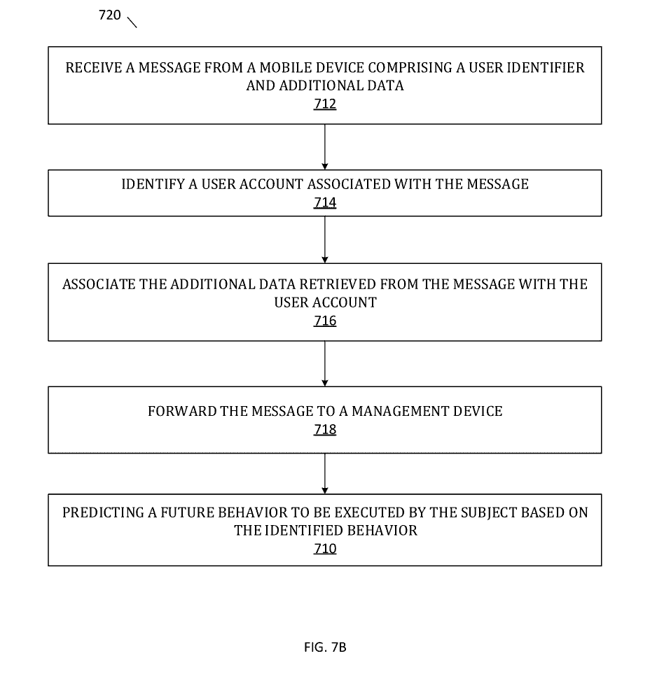

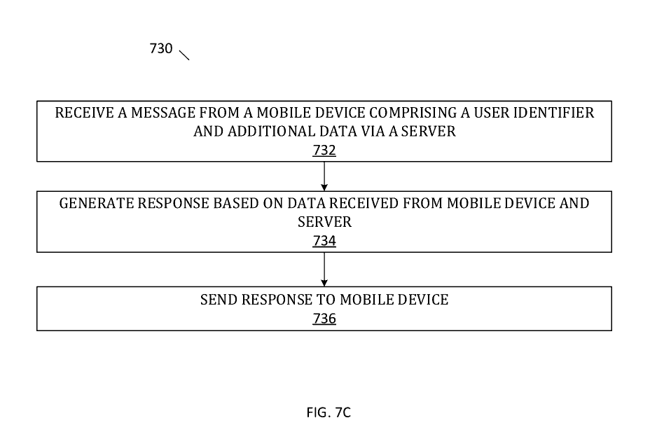

FIGS. 7A, 7B and 7C illustrate examples of operational flows for automating service requests and/or building a database to enable client/service provider communications, arranged in accordance with at least some embodiments described herein. In some portions of the description, illustrative implementations of the method are described with reference to elements of the system 100 depicted in FIGS. 1-6. However, the described embodiments are not limited to these depictions. More specifically, some elements depicted in FIGS. 1-6 may be omitted from some implementations of the methods details herein. Furthermore, other elements not depicted in FIGS. 1-6 may be used to implement example methods detailed herein.

Additionally, FIGS. 7A and 7B employ block diagrams to illustrate the example methods detailed therein. These block diagrams may set out various functional block or actions that may be described as processing steps, functional operations, events and/or acts, etc., and may be performed by hardware, software, and/or firmware. Numerous alternatives to the functional blocks detailed may be practiced in various implementations. For example, intervening actions not shown in the figures and/or additional actions not shown in the figures may be employed and/or some of the actions shown in one figure may be operated using techniques discussed with respect to another figure. Additionally, in some examples, the actions shown in these figures may be operated using parallel processing techniques. The above described, and other not described, rearrangements, substitutions, changes, modifications, etc., may be made without departing from the scope of the claimed subject matter.

In FIG. 7A, in some examples, operational flow 700 may be employed as part of a system for automating service requests and/or building a database to enable client/service provider communications. Operational flow 700 begins at block 702 (“execute an application associated with a client account on a remote server”), wherein mobile device 102 may have application 202 installed thereon (shown in FIG. 1 and FIG. 2). Mobile device 102 may run application 202.

Operational flow 700 continues from block 702 to 704 (“display a user interface on a display of the mobile device including soft buttons”), wherein mobile device 102 may display a user interface responsive to activation of application 202. The interface may include soft buttons.

Operational flow 700 continues from block 704 to 706 (“generate a preformatted and pre-populated outgoing message”), wherein application 202 may generate a message 302 to be sent to server 104 comprising information and other data collected from mobile device 102 or input by a user. Message 302 may be preformatted with text, fields, drop-down lists, and/or address information like or combinations thereof. Message 302 may also be pre-populated with the data collected from mobile device 102. Additionally, message 302 may be automatically populated with data input by the user. In an example, message 302 to be generated responsive to either capturing of an image or activation of a first soft button of the one or more soft buttons.

Operational flow 700 continues from block 706 to 708 (“send the message to a predetermined destination at the remote server”), wherein application 202 may be configured to send the message 302 to a predetermined destination at the remote server responsive to a user input, capturing of an image or attaching the image to the message, or a combination thereof.

In FIG. 7B, in some examples, operational flow 720 may be employed as part of a system for automating service requests and/or building a database to enable client/service provider communications. Operational flow 720 begins at block 712 (“receive a message from a mobile device comprising a user identifier and additional data”), wherein server 104 may receive a message from a mobile device comprising a user identifier and additional data comprising one or more of the following: a service request, an image, a video, an audio message, a review, a keyword or supplemental data, or combination thereof. Operational flow 720 continues from block 712 to 714 (“identify a user account associated with the message”), wherein server 104 may be configured to identify a user account associated with the message, for example, based on a unique ID, email and/or authentication data, or the like or combinations thereof. Operational flow 720 continues from block 714 to 716 (“associate the additional data retrieved from the message with the user account”) wherein server 104 may be configured to associate the additional data retrieved from the message with the user account. Operational flow 720 continues from block 716 to block 718 (forward the message to a management device), wherein server 104 may be configured to forward the message to a management device 106.

In FIG. 7C, in some examples, operational flow 730 may be employed as part of a system for receiving automated service requests and/or building a database to enable client/service provider communications. Operational flow 730 begins at block 732 (“receive a message from a mobile device comprising a user identifier and additional data via a server”), wherein management device 106 running a management version of application 202 may receive a message forwarded by server 104 from a user device 102. The message may comprise data from the original message 302 and additional data added by server 104. Operational flow 730 continues from block 732 to 734 (“generate a response based on data received in message from mobile device and the server”), wherein management device 106 running application 202 may be configured to generate a response to message 302 based on information received in the message sent from the server. The response may be based on data from both server 104 and mobile device 102 such as contact information, service need identified, image identification executed by server, scheduling preferences, treatment plan identified by server, or the like or any combinations thereof. Operational flow 730 continues from block 734 to 736 (“send response to mobile device”) wherein management device 106 running application 202 may be configured to send the response to mobile device 102. The response may be routed through server 104 or sent directly to mobile device 102.

In general, the operational flow described with respect to FIGS. 7A, 7B, 7C and elsewhere herein may be implemented as a computer program product, executable on any suitable computing system, or the like. For example, a computer program product for receiving automated service requests and/or building a database to enable client/service provider communications may be provided.

FIGS. 8A and 8B depict an exemplary process flow 800 for developing an application 202 for automating service requests and/or building a database to facilitate client/service provider communications. In FIG. 8A, process flow 800 begins at block 802 where a content management application may be installed on a website server 104. Process flow 800 continues to block 804, where a mobile application development framework and/or plug-ins may be installed on the website.

Process 800 may continue to block 806, where pages to be used in the application may be designed and coded in any of a variety of coding languages. Process 800 may continue to block 808, where the layout of forms to be used in the pages may be configured. Configuring forms may be executed with original code and/or plug-ins used to create contact forms that may enable collection of information in a variety of contexts such as contact forms, posts, calculators, employment applications etc. Process 800 may continue to block 810, where notification routing for the forms may be configured for example using original code, mobile application development framework and/or plug-ins. Moving to FIG. 8B, process 800 may continue to block 812, where one or more pages may be linked to each other to create a user flow through application 202. Process 800 may move to block 814, where custom code files are created including style.css (with unique artwork/styling) and functions.php (e.g., combined open source code) to create unique styling and functions.

Process 800 may move to block 816, where on-click JavaScript functions may be created within pages to allow specific functionality (e.g., have link open in device's native browser, rather than in-app). Such functions may be compiled in any variety of code languages including open source code.

Process 800 may continue to block 818, where a “config XML” file and native app icons/imagery may be altered to customize applications branding and information. Such alteration may include unique artwork and maybe compiled in any of a variety of languages or using files from app presser, for example. Process 800 continues to block 820 where application 202 may be packaged and submitted to a digital distribution platform for distribution. Process 800 is merely an example of one method of developing an application 202 and claimed subject matter is not limited to this example.

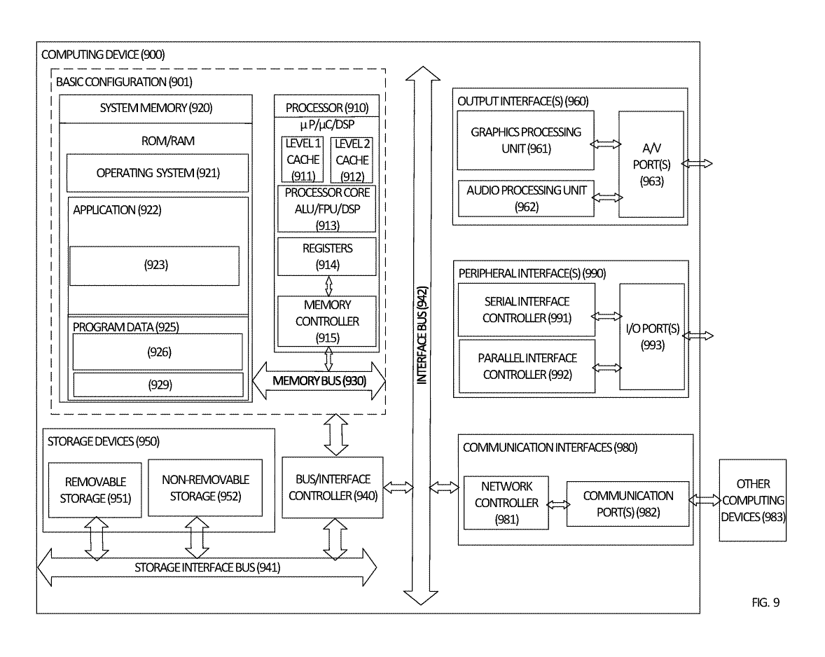

FIG. 9 is a block diagram illustrating an example computing device 900, such as might be embodied by a person skilled in the art, which is arranged in accordance with at least some embodiments of the present disclosure. In one example configuration 901, computing device 900 may include one or more processors 910 and system memory 920. A memory bus 930 may be used for communicating between the processor 910 and the system memory 920.

Processor 910 may be a microprocessor (μP), a microcontroller (μC), a digital signal processor (DSP), or any combination thereof. Processor 910 may include one or more levels of caching, such as a level one cache 911 and a level two cache 912, a processor core 913, and registers 914. The processor core 913 may include an arithmetic logic unit (ALU), a floating point unit (FPU), a digital signal processing core (DSP Core), or any combination thereof. A memory controller 915 may also be used with the processor 910, or in some implementations the memory controller 915 may be an internal part of the processor 910.

System memory 920 may be of any type including volatile memory (e.g., RAM), non-volatile memory (e.g., ROM, flash memory, etc.) or any combination thereof. System memory 920 may include an operating system 921, one or more applications 922, and program data 924. Application 922 may include a message automation and/or database building algorithm 923 that is arranged to perform the functions as described herein including the functional blocks and/or actions described. Program Data 925 may include data 926 including user data, supplemental data, and/or metadata, or the like or any combinations thereof for use with message automation and/or database building algorithm 923. In some example embodiments, application 922 may be arranged to operate with program data 925 on an operating system 921 such that implementations of message automation and/or database building may be provided as described herein. For example, apparatus described in the present disclosure may comprise all or a portion of computing device 900 and be capable of performing all or a portion of application 922 such that implementations of automating one or more service requests and/or building a database to facilitate access to services provided by a service provider may be provided as described herein. This described basic configuration is illustrated in FIG. 9 by those components within dashed line 901.

Computing device 900 may have additional features or functionality, and additional interfaces to facilitate communications between the basic configuration 901 and any required devices and interfaces. For example, a bus/interface controller 940 may be used to facilitate communications between the basic configuration 901 and one or more data storage devices 950 via a storage interface bus 941. The data storage devices 950 may be removable storage devices 951, non-removable storage devices 952, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 920, removable storage 951 and non-removable storage 952 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 900. Any such computer storage media may be part of device 900.

Computing device 900 may also include an interface bus 942 for facilitating communication from various interface devices (e.g., output interfaces, peripheral interfaces, and communication interfaces) to the basic configuration 901 via the bus/interface controller 940. Example output interfaces 960 may include a graphics processing unit 961 and an audio processing unit 962, which may be configured to communicate to various external devices such as a display or speakers via one or more A/V ports 963. Example peripheral interfaces 990 may include a serial interface controller 991 or a parallel interface controller 992, which may be configured to communicate with external devices such as input devices (e.g., keyboard, mouse, pen, voice input device, touch input device, etc.) or other peripheral devices (e.g., printer, scanner, etc.) via one or more I/O ports 993. An example communication interface 980 includes a network controller 981, which may be arranged to facilitate communications with one or more other computing devices 983 over a network communication via one or more communication ports 982. A communication connection is one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared (IR) and other wireless media. The term computer readable media as used herein may include both storage media and communication media.

Computing device 900 may be implemented as a portion of mobile electronic device such as a cell phone, tablet, slate device, wearable computer, computer enabled glasses, a personal data assistant (PDA), a personal media player device, a wireless web-watch device, a personal headset device, an application specific device, or a hybrid device that includes any of the above functions. Computing device 900 may also be implemented as a personal computer including both laptop computer and non-laptop computer configurations. In addition, computing device 900 may be implemented as part of a wireless base station or other wireless system or device.

Some portions of the foregoing detailed description are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated.

Unless specifically stated otherwise, as apparent from the following discussion, it is appreciated that throughout this specification discussions utilizing terms such as “processing,” “computing,” “calculating,” “determining” or the like refer to actions or processes of a computing device, that manipulates or transforms data represented as physical electronic or magnetic quantities within memories, registers, or other information storage devices, transmission devices, or display devices of the computing device.

Claimed subject matter is not limited in scope to the particular implementations described herein. For example, some implementations may be in hardware, such as employed to operate on a device or combination of devices, for example, whereas other implementations may be in software and/or firmware. Likewise, although claimed subject matter is not limited in scope in this respect, some implementations may include one or more articles, such as a signal bearing medium, a storage medium and/or storage media. This storage media, such as CD-ROMs, computer disks, flash memory, or the like, for example, may have instructions stored thereon, that, when executed by a computing device, such as a computing system, computing platform, or other system, for example, may result in execution of a processor in accordance with claimed subject matter, such as one of the implementations previously described, for example. As one possibility, a computing device may include one or more processing units or processors, one or more input/output devices, such as a display, a keyboard and/or a mouse, and one or more memories, such as static random access memory, dynamic random access memory, flash memory, and/or a hard drive.

There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a flexible disk, a hard disk drive (HDD), a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected”, or “coupled”, to each other to achieve the desired functionality, and any two components capable of being so associated can also be viewed as being “coupleable”, to each other to achieve the desired functionality. Specific examples of coupleable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Reference in the specification to “an implementation,” “one implementation,” “some implementations,” or “other implementations” may mean that a particular feature, structure, or characteristic described in connection with one or more implementations may be included in at least some implementations, but not necessarily in all implementations. The various appearances of “an implementation,” “one implementation,” or “some implementations” in the preceding description are not necessarily all referring to the same implementations.

While certain exemplary techniques have been described and shown herein using various methods and systems, it should be understood by those skilled in the art that various other modifications may be made, and equivalents may be substituted, without departing from the claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

What is claimed:

1. A mobile device, comprising:
a processor configured to:
execute an application associated with a client account on a remote server;
display a user interface on a display of the mobile device responsive to activation of the application, the user interface comprising one or more soft buttons configured to be actuated via a user input;
generate a preformatted and pre-populated outgoing message responsive to either capturing of an image or activation of a first soft button of the one or more soft buttons; and
send the message to a predetermined destination at the remote server responsive to a user input, capturing of an image or attaching the image to the message, or a combination thereof.

2. The mobile device of claim 1, wherein the processor is further configured to:
capture an image responsive to activation of a first soft button; and
attach the image in the message.

3. The mobile device of claim 1, wherein the processor is further configured to:
capture a video responsive to activation of a first soft button; and
attach the video in the message.

4. The mobile device of claim 1, wherein the processor is further configured to:
capture audio data responsive to activation of a first soft button; and
attach the audio data in the message.

5. The mobile device of claim 1, wherein the processor is further configured to:
provide a review of services rendered responsive to activation of a first soft button; and
attach the review in the message.

6. The mobile device of claim 2, wherein the processor is further configured to:
display a selectable listing of keywords responsive to capturing the image, wherein the keywords are to be associated with the image; and
populate a predetermined field within the message with keywords from the selectable listing of keywords responsive to a user input.

7. The mobile device of claim 1, wherein the processor is further configured to:
access supplemental data stored on the mobile device; and
insert the supplemental data into a predefined field in the message.

8. The mobile device of claim 7, wherein the supplemental data includes one or more of the following: weather data, location data, social media data, contact data, user data or browsing history, or any combination thereof.

9. The mobile device of claim 1, wherein the pre-populated message includes client information comprising one or more of the following: unique identifier, name, address, account number, phone number, service plan, service history, service preferences, billing plan or payment information or any combination thereof.

10. The mobile device of claim 6, wherein the processor is further configured to send the message to a server configured to copy the image and any keywords present in the message and store the image and any keywords in association with the user account.

11. The mobile device of claim 1, wherein the message is an email message, multimedia messaging service (MMS) message, a Short Message Service (SMS), a software based messaging application message, or a combination thereof.

12. A method comprising:
displaying a user interface on a display of a mobile device responsive to activation of an application associated with a client account on a remote server on the mobile device, the user interface comprising one or more soft buttons configured to be actuated via a user input;
capturing, by the mobile device, an image responsive to a user input activating a first soft button;
generating, by the mobile device, a preformatted and pre-populated outgoing message responsive to either the capturing of the image or activation of a second soft button;
attaching, by the mobile device, the image to the message; and
sending, by the mobile device, the message to a predetermined message address on the server associated with the client account responsive to a user input capturing of the image or attaching the image to the message.

13. The method of claim 12, further comprising:
displaying, by the mobile device, a selectable listing of keywords responsive to capturing the image; and
populating, by the mobile device, a predetermined field within the message with keywords from the selectable listing of keywords responsive to a user selection.

14. The method of claim 12, further comprising:
accessing, by the mobile device, supplemental data stored on the mobile device; and
including, by the mobile device, the supplemental data in the message.

15. The method of claim 14, wherein the supplemental data includes one or more of the following: weather data, location data, social media data, or browsing history, or any combination thereof.

16. The method of claim 12, wherein the pre-populated message includes client information comprising one or more of the following: name, account number, phone number, or address or any combination thereof.

17. The method of claim 12, wherein sending the message to the predetermined message address further comprises sending, by the mobile device, the message to a server configured to copy the image and any keywords present in the message and store the image and any keywords present in association with other.

18. A method comprising:
receiving, at a server, a message from a mobile device comprising a user identifier and additional data comprising one or more of the following: a service request, an image, a video, an audio message, a review, a keyword or supplemental data, or combination thereof;
identifying, by a processor, a user account associated with the message;
associating, by the processor, the additional data retrieved from the message with the user account; and
forwarding, by the processor, the message to a management device.

19. The method of claim 18, further comprising:
identifying, by the processor, one or more first attributes of the image received in the message;
identifying, by the processor, in a database one or more matching second attributes associated with one or more different images in the database; and
providing, by the processor, the one or more different images and associated identifying data to the management device along with the message.

20. The method of claim 18, further comprising:
identifying, by the processor, one or more first attributes of the image received in the message;
saving, by the processor, the image in a database;
identifying, by the processor, the image based on the attributes; and
associating, by the processor, the one or more attributes and the image in the database wherein the image may be searched and identified based on the attributes.
